(19) United States
(12) Patent Application Publication
(10) Pub. No.: US 2025/0232483 A1
(43) Pub. Date: Jul. 17, 2025

(54) METHOD, APPARATUS, AND MEDIUM FOR POINT CLOUD CODING

(71) Applicants: Douyin Vision Co., Ltd., Beijing (CN); Bytedance Inc., Los Angeles, CA (US)

(72) Inventors: Wenyi WANG, Beijing (CN); Yingzhan XU, Beijing (CN); Kai ZHANG, Los Angeles, CA (US); Li ZHANG, Los Angeles, CA (US)

(21) Appl. No.: 19/171,046

(22) Filed: Apr. 4, 2025

Related U.S. Application Data
(63) Continuation of application No. PCT/CN2023/122712, filed on Sep. 28, 2023.

(30) Foreign Application Priority Data
Oct. 4, 2022 (WO) PCT/CN2022/123704

(51) Int. Cl. G06T 9/00

(52) U.S. Cl. CPC G06T 9/001

(57) ABSTRACT

Embodiments of the present disclosure provide a method for point cloud coding. The method comprises: determining, for a conversion between a point cloud sequence comprising a current point cloud (PC) sample associated with a transform block and a bitstream of the point cloud sequence, the transform block comprising a predetermined number of subblocks, each subblock containing at least one point of the point cloud sequence; and performing the conversion by skipping at least one of prediction or transform of the transform block.

### CROSS REFERENCE TO RELATED APPLICATION

This application is a continuation of International Application No. PCT/CN2023/122712, filed on Sep. 28, 2023, which claims the benefit of International Application No. PCT/CN2022/123704 filed on Oct. 4, 2022. The entire contents of these applications are hereby incorporated by reference in their entireties.

### FIELDS

Embodiments of the present disclosure relates generally to point cloud coding techniques, and more particularly, to point cloud attribute coding complexity improvement in region-adaptive hierarchical transform (RAHT).

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for point cloud coding.

In a first aspect, a method for point cloud coding is proposed. The method comprises: determining, for a conversion between a point cloud sequence comprising a current point cloud (PC) sample associated with a transform block and a bitstream of the point cloud sequence, the transform block comprising a predetermined number of subblocks, each subblock containing at least one point of the point cloud sequence; and performing the conversion by skipping at least one of prediction or transform of the transform block.

In a second aspect, an apparatus for point cloud coding is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a point cloud sequence which is generated by a method performed by a point cloud processing apparatus. The method comprises: determining a transform block comprising a predetermined number of subblocks, each subblock containing at least one point of the point cloud sequence, the transform block being associated with a current point cloud (PC) sample comprised in the point cloud sequence; and generating the bitstream by skipping at least one of prediction or transform of the transform block.

In a fifth aspect, a method for storing a bitstream of a point cloud sequence is proposed. The method comprises: determining a transform block comprising a predetermined number of subblocks, each subblock containing at least one point of the point cloud sequence, the transform block being associated with a current point cloud (PC) sample comprised in the point cloud sequence; generating the bitstream by skipping at least one of prediction or transform of the transform block; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder in accordance with some embodiments of the present disclosure;

FIG. 3 illustrates a block diagram that illustrates an example point cloud decoder in accordance with some embodiments of the present disclosure;

FIG. 4 illustrates an example diagram of parent-level nodes for each sub-node of transform unit node in accordance with some embodiments of the present disclosure;

FIG. 5 illustrates an example diagram of the coding flow for the improvement of point cloud attribute coding complexity in accordance with some embodiments of the present disclosure;

FIG. 6 illustrates a flowchart of a method for point cloud coding in accordance with embodiments of the present disclosure; and

FIG. 7 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### EXAMPLE ENVIRONMENT

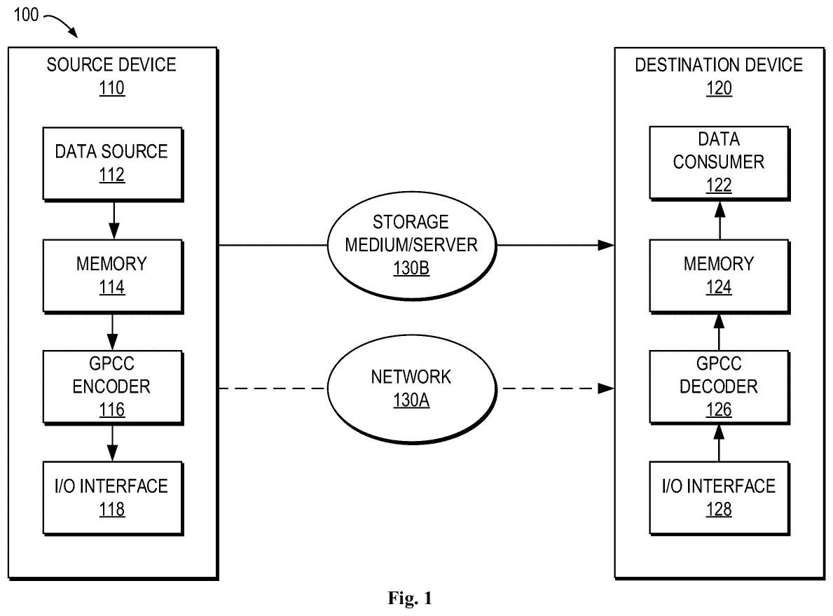

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

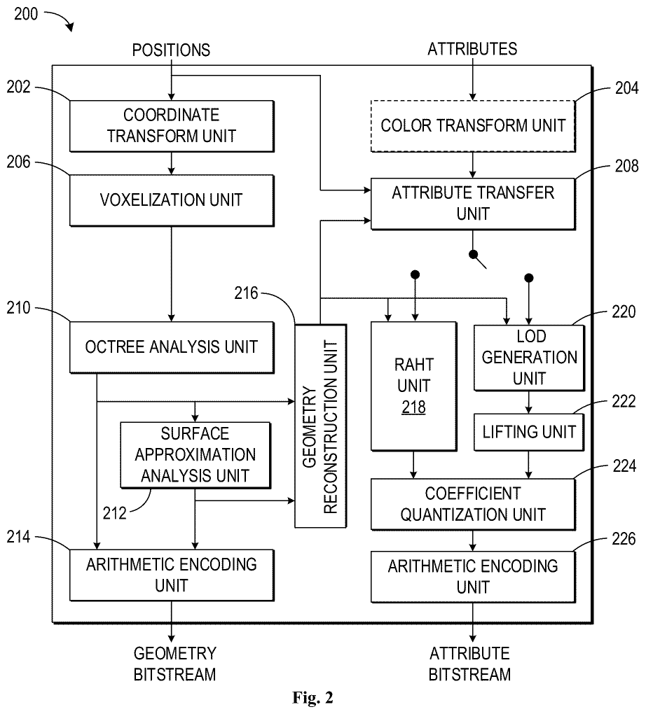

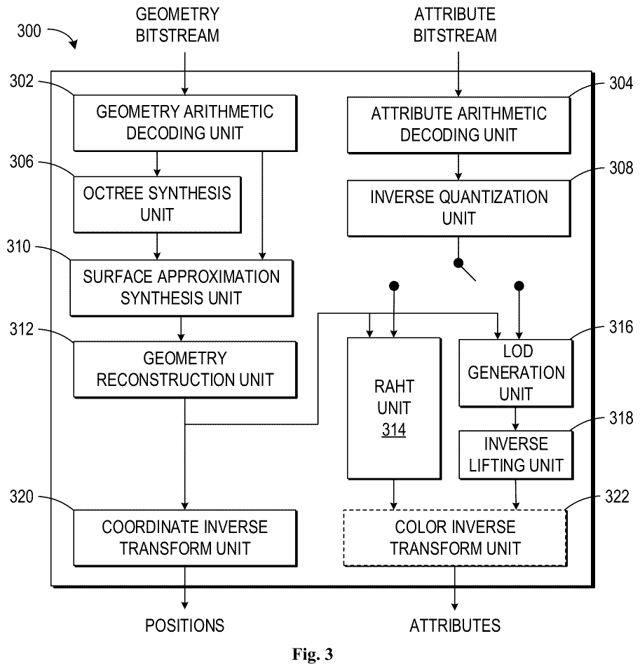

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream. Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. BRIEF SUMMARY

This disclosure is related to point cloud coding technologies. Specifically, it is related to point cloud attribute coding complexity improvement in region-adaptive hierarchical transform (RAHT). The ideas may be applied individually or in various combination, to any point cloud coding standard or non-standard point cloud codec, e.g., the being-developed Geometry based Point Cloud Compression (G-PCC) and Low Latency Low Complexity Codec (L3C2).

### 2. ABBREVIATIONS

G-PCC Geometry based Point Cloud Compression
L3C2 Low Latency Low Complexity Codec
MPEG Moving Picture Experts Group
3DG 3D Graphics Coding Group
CFP Call For Proposal
V-PCC Video-based Point Cloud Compression
RAHT Region-Adaptive Hierarchical Transform
DC Direct Current
AC Alternating Current

### 3. INTRODUCTION

MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions. Both V-PCC and G-PCC support the coding and decoding for single point cloud and point cloud sequence.

In one point cloud, there may be geometry information and attribute information. Geometry information is used to describe the geometry locations of the data points. Attribute information is used to record some details of the data points, such as textures, normal vectors, reflections and so on.

### 3.1 Octree Geometry Compression

Point cloud codec can process the various information in different ways. Usually there are many optional tools in the codec to support the coding and decoding of geometry information and attribute information respectively. Among geometry coding tools in G-PCC, octree geometry compression has an important influence for point cloud geometry coding performance.

In G-PCC, one of important point cloud geometry coding tools is octree geometry compression, which leverages point cloud geometry spatial correlation. If geometry coding tools is enabled, a cubical axis-aligned bounding box, associated with octree root node, will be determined according to point cloud geometry information. Then the bounding box will be subdivided into 8 sub-cubes, which are associated with 8 sub-nodes of root node (a cube is equivalent to node hereafter). An 8-bit code is then generated by specific order to indicate whether the 8 sub-nodes contain points separately, where one bit is associated with one sub-node. The bit associated with one sub-node is named occupancy bit and the 8-bit code generated is named occupancy code. The generated occupancy code will be signaled according to the occupancy information of neighbor node. Then only the nodes which contain points will be subdivided into 8 sub-nodes furtherly. The process will be performed recursively until the node size is 1. So, the point cloud geometry information is converted into occupancy code sequences. In decoder side, occupancy code sequences will be decoded and the point cloud geometry information can be reconstructed according to the occupancy code sequences.

A breadth-first scanning order will be used for the octree. In one level of the octree, the octree node will be scanned in a Morton order. If the coordinate of one node is represented by N bits, the coordinate (X, Y, Z) of the node can be represented as follows.

$$X = ( {x}_{N - 1} {x}_{N - 2} … {x}_{1} {x}_{0} ) \\ Y = ( {y}_{N - 1} {y}_{N - 2} … {y}_{1} {y}_{0} ) \\ Z = ( {z}_{N - 1} {z}_{N - 2} … {z}_{1} {z}_{0} )$$

Its Morton code can be represented as follows.

$$M = ( {x}_{N - 1} {y}_{N - 1} {z}_{N - 1} {x}_{N - 2} {y}_{N - 2} {z}_{N - 2} … {x}_{1} {y}_{1} {z}_{1} {x}_{0} {y}_{0} {z}_{0} )$$

The Morton order is the order from small to large or from large to small according to Morton code.

### 3.2 Region-Adaptive Hierarchical Transform

In G-PCC, one of important point cloud attribute coding tools is RAHT. It is a transform that uses the attributes associated with a node in a lower level of the octree to predict the attributes of the nodes in the next level. It assumes that the positions of the points are given at both the encoder and decoder. RAHT follows the octree scan backwards, from leaf nodes to root node, at each step recombining nodes into larger ones until reaching the root node. At each level of octree, the nodes is processed in the Morton order. At each decomposition, instead of grouping eight nodes at a time, RAHT does it in three steps along each dimension, (e.g., along z, then y then x). If there are L levels in octree, RAHT takes 3 L levels to traverse the tree backwards.

Let the nodes at level l be g_{l,x,y,z}, for x, y, z integers. g_{l,x,y,z} was obtained by grouping g_{l+1,2x,y,z} and g_{l+1,2x+1,y,z}, where the grouping along the first dimension was an example. RAHT only process occupied nodes. If one of the nodes in the pair is unoccupied, the other one is promoted to the next level, unprocessed, i.e., g_{l-1,x,y,z}=g_{l,2x,y,z} if the latter is the occupied node of the pair. The grouping process is repeated until getting to the root. Note that the grouping process generates nodes at lower levels that are the result of grouping different numbers of voxels along the way. The number of nodes grouped to generate node g_{l,x,y,z} is the weight w_{l,x,y,z} of that node.

At every grouping of two nodes, say g_{l,2x,y,z} and g_{l,2x+1,y,z}, with their respective weights, ω_{l,2x,y,z} and ω_{l,2x+1,y,z}, RAHT apply the following transform:

$$[ \begin{matrix}{g}_{l - 1 , x , y , z} \\ {h}_{l - 1 , x , y , z}\end{matrix} ] = {T}_{{ω}_{1} {ω}_{2}} [ \begin{matrix}{g}_{l , 2 x , y , z} \\ {h}_{l , 2 x + 1 , y , z}\end{matrix} ] ,$$

where ω₁=ω_{l,2x,y,z} and ω₂=ω_{l,2x+1,y,z} and

$${T}_{{ω}_{1} {ω}_{2}} = \frac{1}{\sqrt{{ω}_{1} {ω}_{2}}} [ \begin{matrix}\sqrt{{ω}_{1}} & \sqrt{{ω}_{2}} \\ - \sqrt{{ω}_{2}} & \sqrt{{ω}_{1}}\end{matrix} ] .$$

Note that the transform matrix changes at all times, adapting to the weights, i.e., adapting to the number of leaf nodes that each g_{l,x,y,z} actually represents. The quantities g_{l,x,y,z} are used to group and compose further nodes at a lower level. h_{l,x,y,z} are the actual high-pass coefficients generated by the transform to be encoded and transmitted. Furthermore, weights accumulate for the level above. In the above example,

$${ω}_{l - 1 , 2 , y , z} = {ω}_{l , 2 x , y , z} + {ω}_{l , 2 x + 1 , y , z} .$$

In the last stage, the tree root, the remaining two voxels g_{1,0,0,0} and g_{1,1,0,0} are transformed into the final two coefficients as:

$$[ \begin{matrix}{g}_{DC} \\ {h}_{0 , 0 , 0 , 0}\end{matrix} ] = {T}_{{ω}_{1 , 0 , 0 , 0} {ω}_{1 , 1 , 0 , 0}} [ \begin{matrix}{g}_{1 , 0 , 0 , 0} \\ {g}_{1 , 1 , 0 , 0}\end{matrix} ] ,$$

where g_{DC}=g_{0,0,0,0}.

### 3.2.1 Upsampled Transform Domain Prediction

The transform domain prediction is introduced to improve coding efficiency on RAHT. It is formed of two parts. Firstly, the RAHT tree traversal is changed to be descent based from the previous ascent approach, i.e., a tree of attribute and weight sums is constructed and then RAHT is performed from the root level of the tree to the leaves level for both the encoder and the decoder. In each level, the node is visited in Morton order. The transform is performed in node that has 2×2×2 sub-nodes which is in the next level. The node in which transform is performed may be called as transform node.

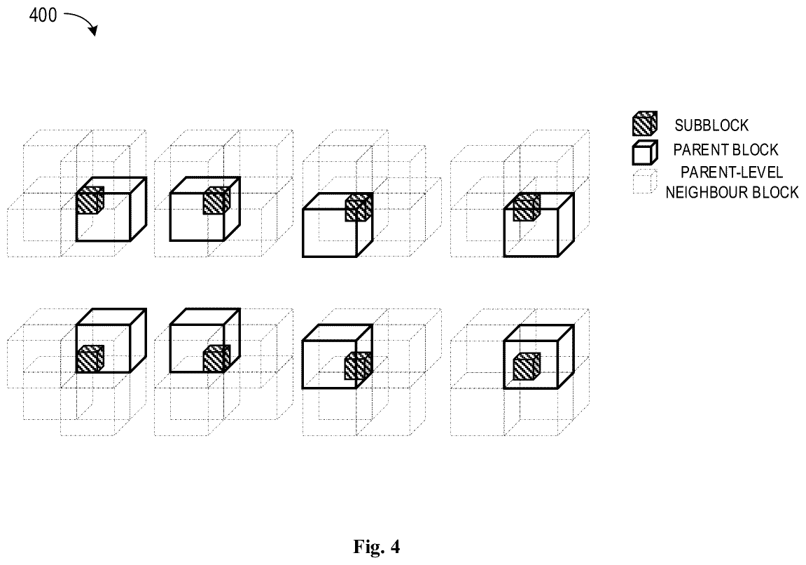

Secondly, for each sub-node of transform node, a corresponding prediction attribute is produced by upsampling the attribute of previous transform level. Actually, only sub-node that contains at last one point will produce a corresponding prediction attribute. The transform node that contains prediction attributes is transformed and subtracted from the transformed attributes at the encoder side. The residual of alternating current (AC) coefficients will be signalled. Note that the prediction does not affect the direct current (DC) coefficient. The each sub-node of transform node is predicted by 7 parent-level nodes where 3 coline parent-level neighbour nodes, 3 coplane parent-level neighbour nodes and 1 parent node. Coplane and coline neighbours are the neighbours that share a face and an edge with current transform node, respectively. A binary search algorithm is used to find coplane and coline parent-level neighbours. FIG. 4 illustrates parent-level nodes for each sub-node of transform unit node. FIG. 4 shows 7 parent-level nodes for each sub-node of transform node.

The attribute aᵤₚ of each sub-node is predicted depending on the distance between it and its parent-level node as follows.

$${a}_{up} = \sum {ω}_{k} {a}_{k} / \sum {ω}_{k}$$

where aₖ is the attribute of its one parent-level node and ωₖ is weight depending on the distance. In G-PCC, ωₚₐᵣₑₙₜ:ω_{coplane}:ω_{coline}=4:2:1.

### 3.2.2 Early Termination for Transform Domain Prediction

Early termination is introduced to reduce complexity. In the upsampled transform domain prediction, 7 parent-level neighbour nodes are used to create the prediction value for each encoding target node (sub-node) of transform node. And there are total 19 parent-level neighbour nodes (containing parent node, i.e. transform unit node) which are used to create the prediction value for all 8 encoding target nodes of transform unit node. The prediction accuracy would be better in the denser point cloud because the number of valid neighbour parent nodes is larger. On the contrary, The prediction accuracy would be worse in the sparser point cloud. Based on this feature, the early termination for upsampled the transform domain prediction is introduced to reduce the coding time. In early termination, the following two parameters in every 8 sub-nodes of transform unit node are calculated.
NumValidP: total number of valid parent-level neighbour node (containing parent node).
NumValidGP: total number of valid grandparent-level neighbour node (containing grandparent node).

Then, the prediction will be disable in case that either NumValidP or NumValidGP is less than threshold. It means that the prediction is terminated when the number of valid neighbour nodes becomes small.

### 3.3 Problems

The existing designs for point cloud attribute transform domain prediction in region-adaptive hierarchical transform have the following problems:

In current design, the neighbour search process will be performed for each transform node to decide whether the early termination is enabled, which causes a high complexity. However, there is no AC coefficients in transform node and the RAHT doesn't need to be performed when there is only one subnode containing points. Hence, the neighbour search process can be skipped in this case to reduce complexity.

### 4. DETAILED SOLUTIONS

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.

1) The prediction operation of one transform node may be skipped.
a. In one example, the transform node may only have one subnode that contains at least one point.
b. In one example, for one transform node, the number of subnodes containing at least one point may be less than or be equal to n, where n is an integer and n may be in a range such as from 1 to 8.
c. In one example, the prediction value may be derived from at least one neighbour, by weighted prediction and any other methods.
   i. In one example, one neighbour may be one node that shares at least a face, or an edge, or a vertex with the transform node.
   ii. In one example, one neighbour may be one node that is closest to the transform node in space distance.
      1. In one example, the distance may be the Euclidean distance, the Manhattan distance, the Chebyshev distance and so on.
   iii. In one example, the neighbour and transform node may share the same octree depth.
   iv. In one example, the neighbour and transform node may have different octree depth.
d. In one example, the transform maybe be region-adaptive hierarchical transform, wavelet transform, cosine transform and so on.
e. In one example, the prediction information may come from the current frame or other frames.
f. In one example, the prediction information may come from at least one frame, which may be the reference frame(s) of the current frame.
   i. In one example, the prediction information may come from one frame.
   ii. In one example, the prediction information may come from two frames.
   iii. In one example, the prediction information may come from n frames, where n is a positive integer.
      1. In one example, n may be signalled to the decoder.
g. In one example, the prediction operation of one transform node may be skipped when the transform node only has one subnode containing points.

2) The early termination for prediction of one transform node may be disabled when the prediction operation is skipped.
a. In one example, if the prediction operation of the parent node is skipped, the early termination of the transform node may be disabled.
b. In one example, if the prediction operation of the transform node is skipped, the early termination of the transform node may be disabled.

3) The neighbor information may be used to decide whether the early termination is disabled for one transform node.
a. In one example, one neighbour may be one node that shares at least a face, or an edge, or a vertex with the parent node.
b. In one example, one neighbour may be one node that is close to the parent node in space distance.
   i. In one example, the distance may be the Euclidean distance, the Manhattan distance, the Chebyshev distance and so on.
c. In one example, the neighbour and parent node may share the same octree depth.
   i. Alternatively, the neighbour and parent node may have different octree depth.
d. In one example, if the neighbour search of the parent node is skipped, the early termination of the transform node may be disabled.
e. In one example, if the neighbour search of transform node is skipped, the early termination of the transform node may be disabled.
f. In one example, if the neighbour number of parent node can not be acquired significantly, the early termination of the transform node may be disabled.
g. In one example, if the neighbour number of the transform node can not be acquired significantly, the early termination of the transform node may be disabled.

4) In one example, the prediction may be performed in different domains.
a. In one example, the prediction may be performed in sample domain.
b. In one example, the prediction may be performed in transform domain.

5) Whether to and/or how to apply the disclosed method may depend on coding/decoding information.
a. In one example, if the transform node may only have one subnode that contains at least one point, the prediction operation of one transform node may be skipped.
b. In one example, if the prediction operation of the parent node is skipped, the early termination of the transform node may be disabled.
c. In one example, if the neighbour search of the parent node is skipped, the early termination of the transform node may be disabled.
   i. In one example one neighbour may be one node that shares at least a face, or an edge, or a vertex with the parent node.
d. In one example, the prediction may be performed in transform domain.

6) Whether to and/or how to apply the disclosed method may be signalled from encoder to decoder
a. In one example, whether the prediction is performed in transform domain or sample domain may be signalled from encoder to decoder.
b. In one example, which frame the prediction information come from may be signalled from encoder to decoder.

### 5. EMBODIMENTS

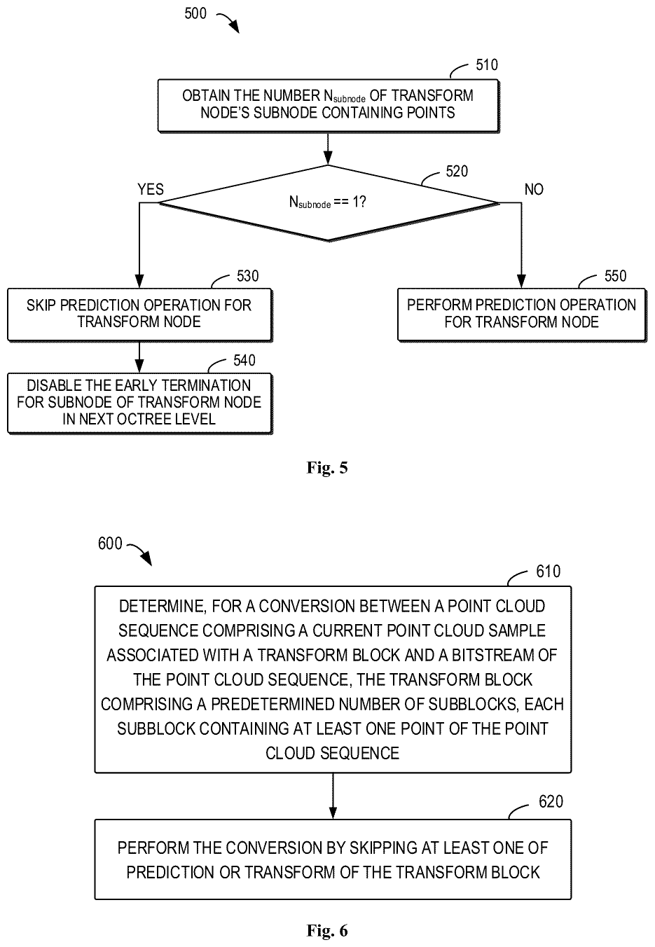

An example of the coding flow for the improvement of point cloud attribute coding complexity is depicted in FIG. 5. At 510, the number (denoted as n_{subnode}) of transform node's subnode containing points is obtained. That is, how many points are included in a transform node is determined first. At 520, it is determined whether the number n_{subnode} is equal to 1. This is to find a transform node that only includes a single point. If n_{subnode} is equal to 1, the flow goes to the “YES” branch and at 530, the prediction operation for the transform node is skipped. Then, at 540, the early termination for subnode of transform node in next octree level is disabled. On the other hand, if the number n_{subnode} is not equal to 1, the flow goes to the “NO” branch and at 550, the prediction operation is performed for the transform node.

More details will be further discussed below. FIG. 6 illustrates a flowchart of a method 600 for point cloud coding in accordance with embodiments of the present disclosure.

It is to be understood that in the following embodiments, the term “transform block” refer to a space in which may have point(s) or may not have any point of the point cloud, and the point(s) in the transform block will be transformed during the conversion between a point cloud sequence and its bitstream. A transform block may comprise one or more subblocks and each subblock may or may not include point(s). A transform block may have one or more neighbor blocks which is adjacent to the transform block.

As to the term “transform node”, it refers to a node representing or corresponding to a transform block, for example, in a tree level. A transform node may have sub-node(s) corresponding to subblocks of a transform block. A transform node may also have a parent node, for example, in a tree level, which corresponds to a parent block comprising the transform block.

At block 610, for a conversion between a point cloud sequence comprising a current point cloud (PC) sample associated with a transform block and a bitstream of the point cloud sequence, the transform block comprising a predetermined number of subblocks is determined. Each of the subblocks contains at least one point of the point cloud sequence.

In some embodiments, the predetermined number is 1. Alternatively, the predetermined number is less than or equal to a positive integer. Alternatively, the predetermined number is less than or equal to a positive integer in a range from 1 to 8.

At block 620, the conversion is performed by skipping at least one of prediction or transform of the transform block.

The method 600 enables that complexity of the prediction, the transform and/or their related operations can be reduced.

In some embodiments, a value of the prediction may be derived from at least one neighbour block of the transform block.

In some embodiments, the neighbour block may be a block that shares at least one of a face, an edge, or a vertex with the transform block, or the neighbour block may be a block that is closest to the transform block in terms of distance, or the neighbour block and the transform block share the same tree level or have different tree levels.

In some embodiments, the distance may be one of a Euclidean distance, a Manhattan distance, or a Chebyshev distance, or a tree level comprises an octree depth.

In some embodiments, the transform may be one of a region-adaptive hierarchical transform, a wavelet transform, a cosine transform.

In some embodiments, prediction information for the prediction may be from a current frame of the transform block, or prediction information for the prediction may be from at least one frame.

In some embodiments, the number of frames in the at least one frame may be a positive integer and/or may be indicated in the bitstream, or the at least one frame comprises a reference frame of the current frame.

In some embodiments, if the prediction of the transform block is skipped, an early termination for the prediction of the transform block may be disabled. Alternatively, or in addition, an early termination for a prediction of a subblock of the transform block may be disabled.

In some embodiments, whether the early termination for the prediction of the transform block may be disabled based on information about one or more neighbor blocks of the transform block.

In some embodiments, one of the neighbor blocks may be a block that shares at least one of a face, an edge, or a vertex with a parent block, the parent block corresponding to a parent node of the transform block. The neighbour block may be a block that is closest to the parent block in terms of distance, or the neighbour block and the transform block may share the same tree level or have different tree levels.

In some embodiments, the distance may be one of a Euclidean distance, a Manhattan distance, or a Chebyshev distance, or wherein a tree level comprises an octree depth.

In some embodiments, if neighbour search of a parent node corresponding to a parent node of the transform block is skipped, the early termination of the transform block may be disabled, or if the neighbour search of the transform block is skipped, the early termination of the transform block may be disabled, or if the number of neighbour blocks of the parent block can not be acquired, the early termination of the transform block is disabled, or if the number of neighbour blocks of the transform block can not be acquired, the early termination of the transform block may be disabled.

In some embodiments, the prediction is performed in different domains.

In some embodiments, the prediction is performed in a sample domain or in a transform domain.

In some embodiments, information on whether to and/or how to apply the method depends on coding/decoding information.

In some embodiments, if the transform block only has one subblock that contains at least one point, the prediction of the transform block is skipped, or if a prediction of a parent block corresponding to a parent node of the transform block is skipped, an early termination of the transform block may be disabled. Alternatively, if neighbor search of the parent block is skipped, the early termination of the transform block may be disabled, or the prediction is performed in transform domain.

In some embodiments, a neighbor block of the parent block shares at least a face, or an edge, or a vertex with the parent block.

In some embodiments, first information on whether the method is to be applied and/or how to apply the method is indicated in the bitstream.

In some embodiments, second information on whether the prediction is performed in transform domain or sample domain is indicated in the bitstream, or third information on which frame the prediction information come from is indicated in the bitstream.

In some embodiments, at least one of the first information, the second information or the third information is indicated from an encoder to a decoder.

In some embodiments, the current PC sample is one of the following: a frame, a picture, a slice, a sub-frame, a sub-picture, a tile, or a segment.

In some embodiments, the conversion includes encoding the current PC sample into the bitstream.

In some embodiments, the conversion includes decoding the current PC sample from the bitstream.

According to further embodiments of the present disclosure, a non-transitory computer-readable recording medium is provided. The non-transitory computer-readable recording medium stores a bitstream of a point cloud sequence which is generated by a method performed by an apparatus for point cloud coding. The method comprises: determining a transform block comprising a predetermined number of subblocks, each subblock containing at least one point of the point cloud sequence, the transform block being associated with a current point cloud (PC) sample comprised in the point cloud sequence; and generating the bitstream by skipping at least one of prediction or transform of the transform block.

According to still further embodiments of the present disclosure, a method for storing bitstream of a point cloud sequence is provided. The method comprises: determining a transform block comprising a predetermined number of subblocks, each subblock containing at least one point of the point cloud sequence, the transform block being associated with a current point cloud (PC) sample comprised in the point cloud sequence; generating the bitstream by skipping at least one of prediction or transform of the transform block; and storing the bitstream in a non-transitory computer-readable recording medium.

Implementations of the present disclosure can be described in view of the following clauses, the features of which can be combined in any reasonable manner.

Clause 1. A method for point cloud coding, comprising: determining, for a conversion between a point cloud sequence comprising a current point cloud (PC) sample associated with a transform block and a bitstream of the point cloud sequence, the transform block comprising a predetermined number of subblocks, each subblock containing at least one point of the point cloud sequence; and performing the conversion by skipping at least one of prediction or transform of the transform block.

Clause 2. The method of clause 1, wherein the predetermined number is 1, or wherein the predetermined number is less than or equal to a positive integer, or wherein the predetermined number is less than or equal to a positive integer in a range from 1 to 8.

Clause 3. The method of clause 1, wherein a value of the prediction is derived from at least one neighbour block of the transform block.

Clause 4. The method of clause 3, wherein the neighbour block is a block that shares at least one of a face, an edge, or a vertex with the transform block, or wherein the neighbour block is a block that is closest to the transform block in terms of distance, or wherein the neighbour block and the transform block share the same tree level or have different tree levels.

Clause 5. The method of clause 4, wherein the distance is one of a Euclidean distance, a Manhattan distance, or a Chebyshev distance, or wherein a tree level comprises an octree depth.

Clause 6. The method of clause 1, wherein the transform is one of a region-adaptive hierarchical transform, a wavelet transform, a cosine transform.

Clause 7. The method of clause 1, wherein prediction information for the prediction is from a current frame of the transform block, or wherein prediction information for the prediction is from at least one frame.

Clause 8. The method of clause 7, wherein the number of frames in the at least one frame is a positive integer and/or is indicated in the bitstream, or wherein the at least one frame comprises a reference frame of the current frame.

Clause 9. The method of clause 1, wherein if the prediction of the transform block is skipped, at least one of the following is disabled: an early termination for the prediction of the transform block, or an early termination for a prediction of a subblock of the transform block.

Clause 10. The method of clause 9, wherein whether the early termination for the prediction of the transform block is disabled based on information about one or more neighbor blocks of the transform block.

Clause 11. The method of clause 10, wherein one of the neighbor blocks is a block that shares at least one of a face, an edge, or a vertex with a parent block, the parent block corresponding to a parent node of the transform block, wherein the neighbour block is a block that is closest to the parent block in terms of distance, or wherein the neighbour block and the transform block share the same tree level or have different tree levels.

Clause 12. The method of clause 11, wherein the distance is one of a Euclidean distance, a Manhattan distance, or a Chebyshev distance, or wherein a tree level comprises an octree depth.

Clause 13. The method of clause 9, wherein if neighbour search of a parent node corresponding to a parent node of the transform block is skipped, the early termination of the transform block is disabled, or if the neighbour search of the transform block is skipped, the early termination of the transform block is disabled, or if the number of neighbour blocks of the parent block can not be acquired, the early termination of the transform block is disabled, or if the number of neighbour blocks of the transform block can not be acquired, the early termination of the transform block is disabled.

Clause 14. The method of clause 1, wherein the prediction is performed in different domains.

Clause 15. The method of clause 14, wherein the prediction is performed in a sample domain or in a transform domain.

Clause 16. The method of any of clauses 1 to 15, wherein information on whether to and/or how to apply the method depends on coding/decoding information.

Clause 17. The method of clause 16, wherein if the transform block only has one subblock that contains at least one point, the prediction of the transform block is skipped, or wherein if a prediction of a parent block corresponding to a parent node of the transform block is skipped, an early termination of the transform block is disabled, or wherein if neighbor search of the parent block is skipped, the early termination of the transform block is disabled, or wherein the prediction is performed in transform domain.

Clause 18. The method of clause 17, wherein a neighbor block of the parent block shares at least a face, or an edge, or a vertex with the parent block.

Clause 19. The method of clause 1, wherein first information on whether the method is to be applied and/or how to apply the method is indicated in the bitstream.

Clause 20. The method of clause 19, wherein second information on whether the prediction is performed in transform domain or sample domain is indicated in the bitstream, or wherein third information on which frame the prediction information come from is indicated in the bitstream.

Clause 21. The method of clause 20, wherein at least one of the first information, the second information or the third information is indicated from an encoder to a decoder.

Clause 22. The method of any of clauses 1-21, wherein the current PC sample is one of the following: a frame, a picture, a slice, a sub-frame, a sub-picture, a tile, or a segment.

Clause 23. The method of any of clauses 1-22, wherein the conversion includes encoding the current PC sample into the bitstream.

Clause 24. The method of any of clauses 1-22, wherein the conversion includes decoding the current PC sample from the bitstream.

Clause 25. An apparatus for point cloud coding comprising a processor and a non-transitory memory with instructions thereon, wherein the instructions upon execution by the processor, cause the processor to perform a method in accordance with any of clauses 1-24.

Clause 26. A non-transitory computer-readable storage medium storing instructions that cause a processor to perform a method in accordance with any of clauses 1-24.

Clause 27. A non-transitory computer-readable recording medium storing a bitstream of a point cloud sequence which is generated by a method performed by a point cloud processing apparatus, wherein the method comprises: determining a transform block comprising a predetermined number of subblocks, each subblock containing at least one point of the point cloud sequence, the transform block being associated with a current point cloud (PC) sample comprised in the point cloud sequence; and generating the bitstream by skipping at least one of prediction or transform of the transform block.

Clause 28. A method for storing a bitstream of a point cloud sequence, comprising: determining a transform block comprising a predetermined number of subblocks, each subblock containing at least one point of the point cloud sequence, the transform block being associated with a current point cloud (PC) sample comprised in the point cloud sequence; generating the bitstream by skipping at least one of prediction or transform of the transform block; and storing the bitstream in a non-transitory computer-readable recording medium.

### Example Device

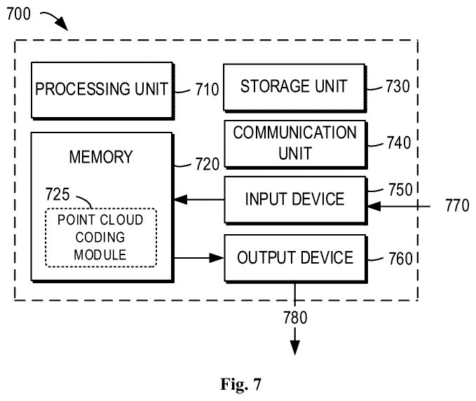

FIG. 7 illustrates a block diagram of a computing device 700 in which various embodiments of the present disclosure can be implemented. The computing device 700 may be implemented as or included in the source device 110 (or the GPCC encoder 116 or 200) or the destination device 120 (or the GPCC decoder 126 or 300).

It would be appreciated that the computing device 700 shown in FIG. 7 is merely for purpose of illustration, without suggesting any limitation to the functions and scopes of the embodiments of the present disclosure in any manner.

As shown in FIG. 7, the computing device 700 includes a general-purpose computing device 700. The computing device 700 may at least comprise one or more processors or processing units 710, a memory 720, a storage unit 730, one or more communication units 740, one or more input devices 750, and one or more output devices 760.

In some embodiments, the computing device 700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 700 can support any type of interface to a user (such as “wearable” circuitry and the like).

The processing unit 710 may be a physical or virtual processor and can implement various processes based on programs stored in the memory 720. In a multi-processor system, multiple processing units execute computer executable instructions in parallel so as to improve the parallel processing capability of the computing device 700. The processing unit 710 may also be referred to as a central processing unit (CPU), a microprocessor, a controller or a microcontroller.

The computing device 700 typically includes various computer storage medium. Such medium can be any medium accessible by the computing device 700, including, but not limited to, volatile and non-volatile medium, or detachable and non-detachable medium. The memory 720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 730 may be any detachable or non-detachable medium and may include a machine-readable medium such as a memory, flash memory drive, magnetic disk or another other media, which can be used for storing information and/or data and can be accessed in the computing device 700.

The computing device 700 may further include additional detachable/non-detachable, volatile/non-volatile memory medium. Although not shown in FIG. 7, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 740 communicates with a further computing device via the communication medium. In addition, the functions of the components in the computing device 700 can be implemented by a single computing cluster or multiple computing machines that can communicate via communication connections. Therefore, the computing device 700 can operate in a networked environment using a logical connection with one or more other servers, networked personal computers (PCs) or further general network nodes.

The input device 750 may be one or more of a variety of input devices, such as a mouse, keyboard, tracking ball, voice-input device, and the like. The output device 760 may be one or more of a variety of output devices, such as a display, loudspeaker, printer, and the like. By means of the communication unit 740, the computing device 700 can further communicate with one or more external devices (not shown) such as the storage devices and display device, with one or more devices enabling the user to interact with the computing device 700, or any devices (such as a network card, a modem and the like) enabling the computing device 700 to communicate with one or more other computing devices, if required. Such communication can be performed via input/output (I/O) interfaces (not shown).

In some embodiments, instead of being integrated in a single device, some or all components of the computing device 700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 700 may be used to implement point cloud encoding/decoding in embodiments of the present disclosure. The memory 720 may include one or more point cloud coding modules 725 having one or more program instructions. These modules are accessible and executable by the processing unit 710 to perform the functionalities of the various embodiments described herein.

In the example embodiments of performing point cloud encoding, the input device 750 may receive point cloud data as an input 770 to be encoded. The point cloud data may be processed, for example, by the point cloud coding module 725, to generate an encoded bitstream. The encoded bitstream may be provided via the output device 760 as an output 780.

In the example embodiments of performing point cloud decoding, the input device 750 may receive an encoded bitstream as the input 770. The encoded bitstream may be processed, for example, by the point cloud coding module 725, to generate decoded point cloud data. The decoded point cloud data may be provided via the output device 760 as the output 780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1. A method for point cloud coding, comprising:
determining, for a conversion between a point cloud sequence comprising a current point cloud (PC) sample associated with a transform block and a bitstream of the point cloud sequence, the transform block comprising a predetermined number of subblocks, each subblock containing at least one point of the point cloud sequence; and
performing the conversion by skipping at least one of prediction or transform of the transform block.

2. The method of claim 1, wherein the predetermined number is 1, or
wherein the predetermined number is less than or equal to a positive integer, or
wherein the predetermined number is less than or equal to a positive integer in a range from 1 to 8.

3. The method of claim 1, wherein a value of the prediction is derived from at least one neighbour block of the transform block.

4. The method of claim 3, wherein the neighbour block is a block that shares at least one of a face, an edge, or a vertex with the transform block, or
wherein the neighbour block is a block that is closest to the transform block in terms of distance, or
wherein the neighbour block and the transform block share the same tree level or have different tree levels,
wherein the distance is one of a Euclidean distance, a Manhattan distance, or a Chebyshev distance, or
wherein a tree level comprises an octree depth.

5. The method of claim 1, wherein the transform is one of a region-adaptive hierarchical transform, a wavelet transform, a cosine transform.

6. The method of claim 1, wherein prediction information for the prediction is from a current frame of the transform block, or
wherein prediction information for the prediction is from at least one frame, and/or
wherein the number of frames in the at least one frame is a positive integer and/or is indicated in the bitstream, or
wherein the at least one frame comprises a reference frame of the current frame.

7. The method of claim 1, wherein if the prediction of the transform block is skipped, at least one of the following is disabled:
an early termination for the prediction of the transform block, or
an early termination for a prediction of a subblock of the transform block.

8. The method of claim 7, wherein whether the early termination for the prediction of the transform block is disabled based on information about one or more neighbor blocks of the transform block.

9. The method of claim 8, wherein one of the neighbor blocks is a block that shares at least one of a face, an edge, or a vertex with a parent block, the parent block corresponding to a parent node of the transform block,
wherein the neighbour block is a block that is closest to the parent block in terms of distance, or
wherein the neighbour block and the transform block share the same tree level or have different tree levels, and/or
wherein the distance is one of a Euclidean distance, a Manhattan distance, or a Chebyshev distance, or
wherein a tree level comprises an octree depth.

10. The method of claim 7, wherein if neighbour search of a parent node corresponding to a parent node of the transform block is skipped, the early termination of the transform block is disabled, or
if the neighbour search of the transform block is skipped, the early termination of the transform block is disabled, or
if the number of neighbour blocks of the parent block can not be acquired, the early termination of the transform block is disabled, or
if the number of neighbour blocks of the transform block can not be acquired, the early termination of the transform block is disabled.

11. The method of claim 1, wherein the prediction is performed in different domains.

12. The method of claim 11, wherein the prediction is performed in a sample domain or in a transform domain.

13. The method of claim 1, wherein information on whether to and/or how to apply the method depends on coding/decoding information.

14. The method of claim 13, wherein if the transform block only has one subblock that contains at least one point, the prediction of the transform block is skipped, or
wherein if a prediction of a parent block corresponding to a parent node of the transform block is skipped, an early termination of the transform block is disabled, or
wherein if neighbor search of the parent block is skipped, the early termination of the transform block is disabled, or
wherein the prediction is performed in transform domain, and/or
wherein a neighbor block of the parent block shares at least a face, or an edge, or a vertex with the parent block.

15. The method of claim 1, wherein the current PC sample is one of the following:
a frame,
a picture,
a slice,
a sub-frame,
a sub-picture,
a tile, or
a segment.

16. The method of claim 1, wherein the conversion includes encoding the current PC sample into the bitstream.

17. The method of claim 1, wherein the conversion includes decoding the current PC sample from the bitstream.

18. An apparatus for point cloud coding comprising a processor and a non-transitory memory with instructions thereon, wherein the instructions upon execution by the processor, cause the processor to perform a method comprising:
determining, for a conversion between a point cloud sequence comprising a current point cloud (PC) sample associated with a transform block and a bitstream of the point cloud sequence, the transform block comprising a predetermined number of subblocks, each subblock containing at least one point of the point cloud sequence; and
performing the conversion by skipping at least one of prediction or transform of the transform block.

19. A non-transitory computer-readable storage medium storing instructions that cause a processor to perform a method comprising:
determining, for a conversion between a point cloud sequence comprising a current point cloud (PC) sample associated with a transform block and a bitstream of the point cloud sequence, the transform block comprising a predetermined number of subblocks, each subblock containing at least one point of the point cloud sequence; and
performing the conversion by skipping at least one of prediction or transform of the transform block.

20. A non-transitory computer-readable recording medium storing a bitstream of a point cloud sequence which is generated by a method performed by a point cloud processing apparatus, wherein the method comprises:
determining a transform block comprising a predetermined number of subblocks, each subblock containing at least one point of the point cloud sequence, the transform block being associated with a current point cloud (PC) sample comprised in the point cloud sequence; and
generating the bitstream by skipping at least one of prediction or transform of the transform block.
